(19) United States
(12) Patent Application Publication
(10) Pub. No.: US 2012/0130798 A1
(43) Pub. Date: May 24, 2012

(54) MODEL SEQUENCING FOR MANAGING ADVERTISING PRICING

(76) Inventors: Robert W. Cooley, St. Paul, MN (US); Douglas Bryan, Buffalo Grove, IL (US)

(21) Appl. No.: 12/953,150

(22) Filed: Nov. 23, 2010

(51) Int. Cl. G06Q 30/00

(52) U.S. Cl. 705/14.41

(57) ABSTRACT

Methods and systems for determining a price for an advertising placement. One method includes setting a desired placement location for an advertising placement; determining a predicted number of views at the desired placement location for the advertising placement using a views model; determining a predicted cost at the desired placement location for the advertising placement using a cost model, the cost model using the predicted number of views determined by the views model as input; and outputting a price for the advertising placement based on at least one of the predicted number of views and the predicted cost at the desired placement location.

### FIELD OF THE INVENTION

Embodiments of the invention relate to systems and methods for managing advertising placement pricing. In particular, embodiments of the invention use sequences of multi-variate models to simulate future performance of an advertisement.

### BACKGROUND OF THE INVENTION

The purchasing of advertising, also known as media buying, is useful for many forms or channels of advertising, such as Internet paid search advertising, Internet display advertising, television advertising, radio advertising, newspaper advertising, mobile device advertising, magazine advertising, and outdoor advertising. Advertising pricing and placement factors, however, can vary by advertising channel and provider. For example, the pricing for Internet paid search advertising offered by the Google® AdWords® program is a modified second price auction, which differs from the pricing mechanism used in many other channels and forms of advertising.

To manage the pricing and placement factors for one or more advertising channels or providers, an advertiser can use an advertising management system. For example, computer-implemented methods and systems designed to manage the price paid for advertising placements are referred to as advertising price management applications or systems. In addition, computer-implemented software methods and systems designed to manage Internet paid search advertising are referred to as paid search bid management applications or systems. The number of pricing and placement factors associated with a particular advertising channel and provider and the goals of an advertiser, however, can become very complex, especially given the dynamic and fast-paced nature of Internet advertising. With many advertisers spending large amounts of money on Internet-based advertising, these complexities need to be properly handled to provide successful and efficient advertising management.

### SUMMARY OF THE INVENTION

Across the various advertising channels, there are millions of individual advertising placement opportunities available to an advertiser. However, the pricing mechanisms and available methods for tracking advertising results differ from one advertising channel to the next and from one provider to the next. This makes it difficult for an advertiser to determine the appropriate price to pay for a given advertising placement opportunity.

Within the context of the Internet, advertisers can bid on a set of keywords or keyword phrases and the search engine or other online system providing the advertising opportunity can allocate advertising positions based on the highest bidder. However, given the dynamic and fast-paced nature of the Internet, it is often difficult for advertisers to effectively manage their bids for online advertisements. For example, keywords or keyword phrases that an advertiser may initially select as being related to a particular advertisement may yield too few or too many impressions (i.e., displays on a search results page), clicks, or business events (i.e., activity by a user after clicking on an advertisement, such as a sale or registration) over time based on various factors including other bidders, changes in common terms or usage of terms, weekly or seasonal search habits or shopping habits of users, etc. Being able to effectively manage and monitor such factors can increase an advertiser's efficient use of advertisement resources.

Accordingly, embodiments of the invention provide a computer-implemented method for determining a price for an advertisement. The method includes setting a desired placement location for an advertisement; determining a predicted number of views at the desired placement location for the advertisement using a views model; determining a predicted cost at the desired placement location for the advertisement using a cost model, the cost model using the predicted number of views determined by the views model as input; and outputting a price for the advertisement based on at least one of the predicted number of views and the predicted cost at the desired placement location.

Embodiments of the invention also provide a system for determining a bid for an advertisement displayed in response to a search query. The system includes a clicks model configured to determine a predicted number of clicks at a desired position for an advertisement, a cost model configured to determine a predicted cost at the desired position for the advertisement using the predicted number of clicks determined by the clicks model as input, and a module configured to output a bid for the advertisement to at least one paid search server based on at least one of the predicted number of clicks and the predicted cost at the desired position.

In addition, embodiments of the invention provide non-transitory computer-readable medium encoded with a plurality of processor-executable instructions. The instructions include setting a desired position for an advertisement; determining a predicted number of clicks at the desired position for the advertisement using a clicks model; determining a predicted cost at the desired position for the advertisement using a cost model, the cost model using the predicted number of clicks determined by the clicks model as input; and outputting a bid for the advertisement to at least one paid search server based on at least one of the predicted number of clicks and the predicted cost at the desired position.

Further embodiments of the invention also provide a system for determining a bid for an advertisement. The system includes a first model configured to output a predicted number of customer impressions at a desired position for an advertisement, a second model configured to output a predicted cost for the advertisement using an output of the first model as input, and a module configured to output a bid for the advertisement based on the output of at least one of the first model and the second model.

Other aspects of the invention will become apparent by consideration of the detailed description and accompanying drawings.

### BRIEF DESCRIPTION OF THE DRAWINGS

FIG. 1 illustrates a search results page including search results and advertisements.

FIG. 2 schematically illustrates an advertising management system.

FIG. 3 schematically illustrates the system of FIG. 2 configured as a model-based advertising price management system.

FIG. 4 schematically illustrates the system of FIG. 2 configured as a model-based paid search bid management system.

FIGS. 5-8 illustrate methods of predicting future performance of an advertising placement performed by the system of FIGS. 3 and 4.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein are for the purpose of description and should not be regarded as limiting. The use of “including,” “comprising,” or “having” and variations thereof herein are meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings.

In addition, it should be understood that embodiments of the invention may include hardware, software, and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic based aspects of the invention may be implemented in software (e.g., stored on non-transitory computer-readable medium). As such, it should be noted that a plurality of hardware and software based devices, as well as a plurality of different structural components may be utilized to implement embodiments of the invention.

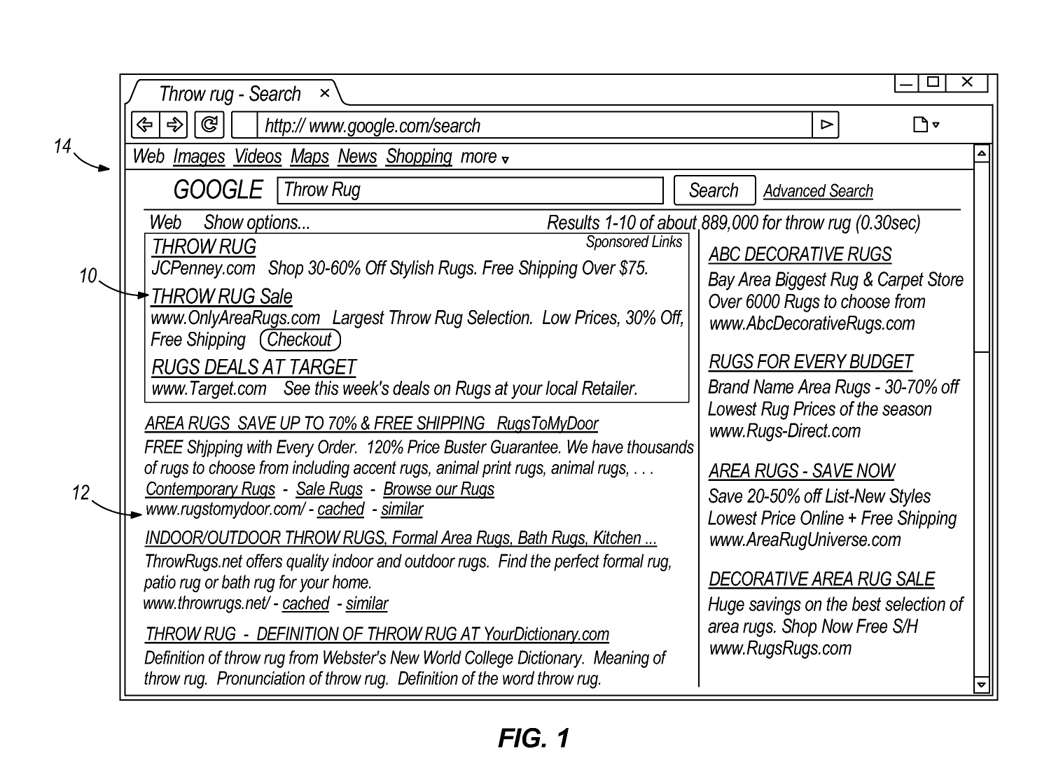

In the context of advertising, “business events” are actions considered to be of value to an advertiser, such as conversions, orders or sales, leads, or applications or registrations. Business events can be assigned a “business value,” such as revenue, margin, or profit. As described above, in Internet paid search advertising, advertisements are displayed along with Internet search results. An advertising placement, or simply a placement, is an advertising opportunity that can be purchased. In the context of Internet paid searches, a placement is typically associated with a “keyword phrase,” and the advertising opportunity comes in the form of one or more “sponsored links” 10 that are displayed along with “natural” or “organic” search results 12 on a search results page 14, as shown in FIG. 1.

The number of times an advertisement is displayed is referred to as “impressions.” After an impression, various events can occur. For example, in the context of non-Internet-based advertising, if a user views a displayed advertisement, the event is referred to as “view.” Within the context of Internet-based advertising, if a hypertext link associated with an advertisement is selected by an individual, the event is referred to as a “click-through” or simply a “click.” The click event leads a user to an advertiser's web site or page, presumably where goods or services are offered, which may potentially lead to another business event. Therefore, advertisement impressions can lead to clicks, which can lead to business events, which have a business value.

There is a cost associated with each click or view, which is often referred to as a “cost-per-click” (“CPC”) or a “cost-per-view” (“CPV”). For many Internet paid searches, the CPC is determined through a modified second price auction. The auction and modifications to the auction are managed by the paid search servers or other online systems offering the advertising opportunity, such as Google® for Google® AdWords® or Microsoft® for Microsoft® AdCenter®. Some online systems modify the advertising auction by looking at more than just an advertiser's bid. For example, some online systems apply a weight to an advertiser's bid that accounts for factors such as “relevance” or “click through rate” of a particular advertiser or advertisement (e.g., based on historical information). However, the exact nature and details of the weights are not provided by the online systems to an advertiser. Therefore, an advertiser provides a maximum CPC, also known as a bid, to the paid search server that represents what the advertiser is willing to pay for a particular event for a particular advertisement associated with a particular search keyword phrase without knowing exactly what will be the result of the bid.

At the time of a search, all of the potential advertisers are ranked based on their bids (e.g., modified by any weights or other factors). The actual CPC an advertiser pays and the resulting position on the search results page of a particular advertisement is dependent on the other advertisers' bids and any modifications applied to those bids. Over a given period of time, such as one day, the cost for a particular keyword is calculated as the average CPC for that time period multiplied by the number of clicks on the advertisement associated with the keyword.

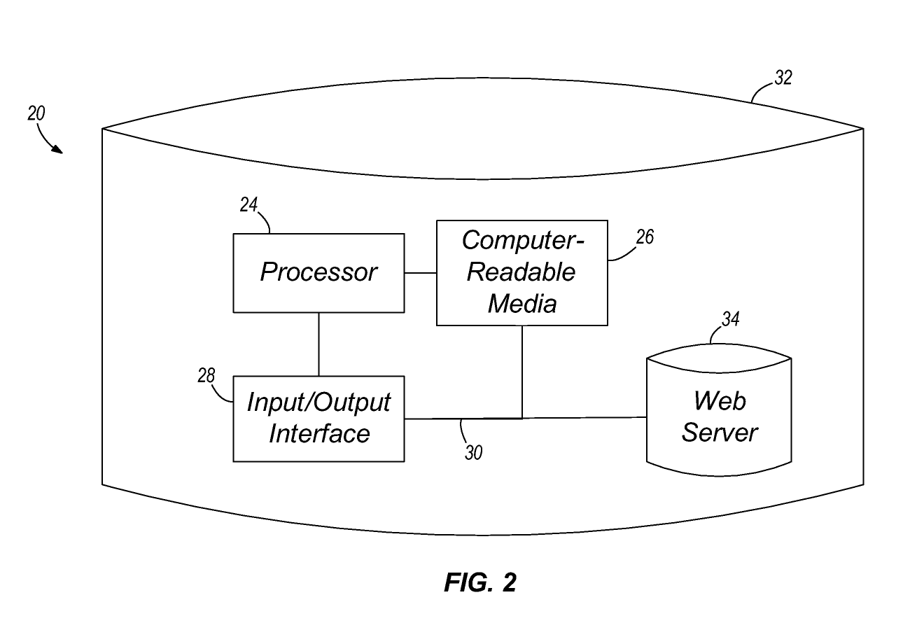

As mentioned above, advertising price management applications or systems can be used to manage advertising, such as Internet paid search advertising. FIG. 2 illustrates an advertising price management system 20 according to one embodiment of the invention. It should be understood that FIG. 2 illustrates only one example of components of an advertising price management system 20 and that other configurations are possible. As shown in FIG. 2, the system 20 includes a processor 24, computer-readable media 26, and an input/output interface 28. The processor 24, computer-readable media 26, and input/output interface 28 are connected by one or more connections 30, such as a system bus. It should be understood that although the processor 24, computer-readable media 26, and input/output interface 28 are illustrated as part of a single server or other computing device 32, the components of the system 20 can be distributed over multiple servers or computing devices. Similarly, the system 20 can include multiple processors 24, computer-readable media 26, and input/output interfaces 28.

The processor 24 retrieves and executes instructions stored in the computer-readable media 26. The processor 24 can also store data to the computer-readable media 26. The computer-readable media 26 can include non-transitory computer readable medium and can include volatile memory, non-volatile memory, or a combination thereof. In some embodiments, the computer-readable media 26 includes a disk drive or other types of large capacity storage mechanism. The computer-readable media 26 can also include a database structure that stores data processed by the system 20 or otherwise obtained by the system 20.

The input/output interface 28 receives information from outside the system 20 and outputs information outside the system 20. For example, the input/output interface 28 can include a network interface, such as an Ethernet card or a wireless network card, that allows the system 20 to send and receive information over a network, such as a local area network or the Internet. In some embodiments, the input/output interface 28 includes drivers configured to receive and send data to and from various input and/or output devices, such as a keyboard, a mouse, a printer, a monitor, etc.

As shown in FIG. 2, the system 20 can also include a web server 34, such as an Apache® web server. The web server 34 can include a processor and computer-readable media and can be used by the system 20 to provide data (e.g., reports) and interfaces. For example, as described below, a user may access an interface of the system 20 through a browser application, such as Internet Explorer®, Firefox®, Chrome®, etc., that allows the user to obtain data or reports or configure and/or monitor the system 20.

The instructions stored in the computer-readable media 26 can include various components or modules configured to perform particular functionality when executed by the processor 24. For example, advertising price management systems are typically either rule-based, model-based, or hybrid systems that combine rules and models. Rule-based systems take specific rules as inputs, such as “if the cost per conversion exceeds $50 then lower the price paid per advertisement by 10%,” and apply the rules based on current factors or situations. Model-based systems use observations of previous performance to simulate or “predict” future performance. In general, various forms of predictive models may be used in model-based systems, such as regression polynomials, decisions trees, or neural networks. Model-based systems are often coupled with constraint-based optimizers to explore several simulated outcomes resulting from future advertisement price settings.

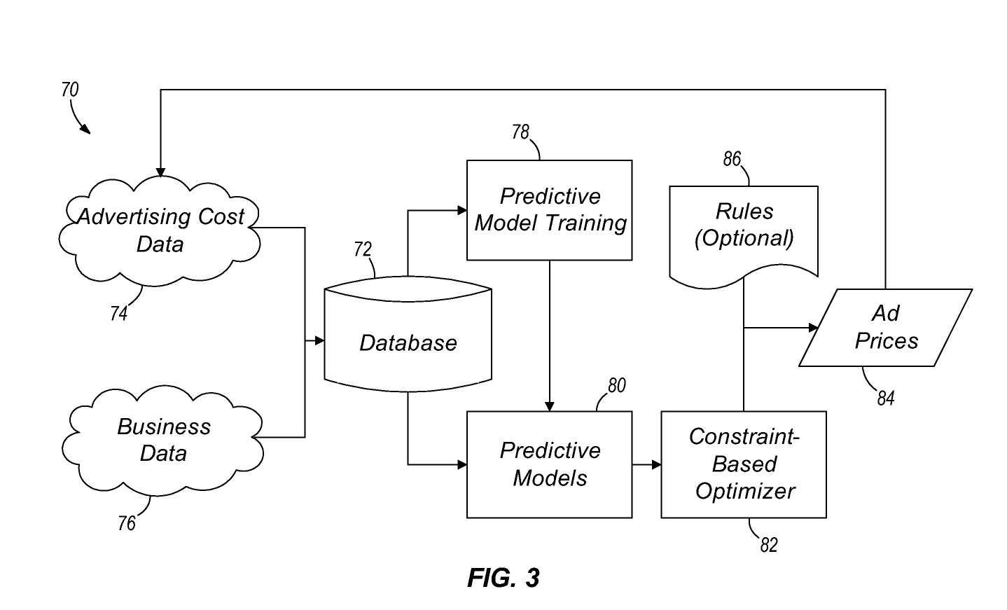

For example, FIG. 3 illustrates the system 20 configured as a model-based advertising price management application system 70. The system 70 includes a database 72 that obtains advertising cost data 74 and business data 76. The database 72 obtains the advertising cost data 74 and/or the business data 76 from one or more sources, including from an advertiser and/or from an advertising entity or publisher. The advertising cost data 74 and/or business data 76 can include information such as cost data from the publisher, historical advertising reports or data, etc.

The information stored in the database 72 is used by a predictive model training module 78 that generates one or more predictive models 80, such as multivariate predictive models. The predictive models 80 are used by a constraint-based optimizer 82 to determine advertisement prices 84. As shown in FIG. 3, one or more rules 86 may also optionally be used to determine advertisement prices 84. If rules 86 are used, the system 70 can be considered a hybrid advertising price management system. The advertisement prices 84 generated by the system 70 are fed back into the advertising cost data 74, which can be used by the publisher and/or by the system 70 during subsequent processing.

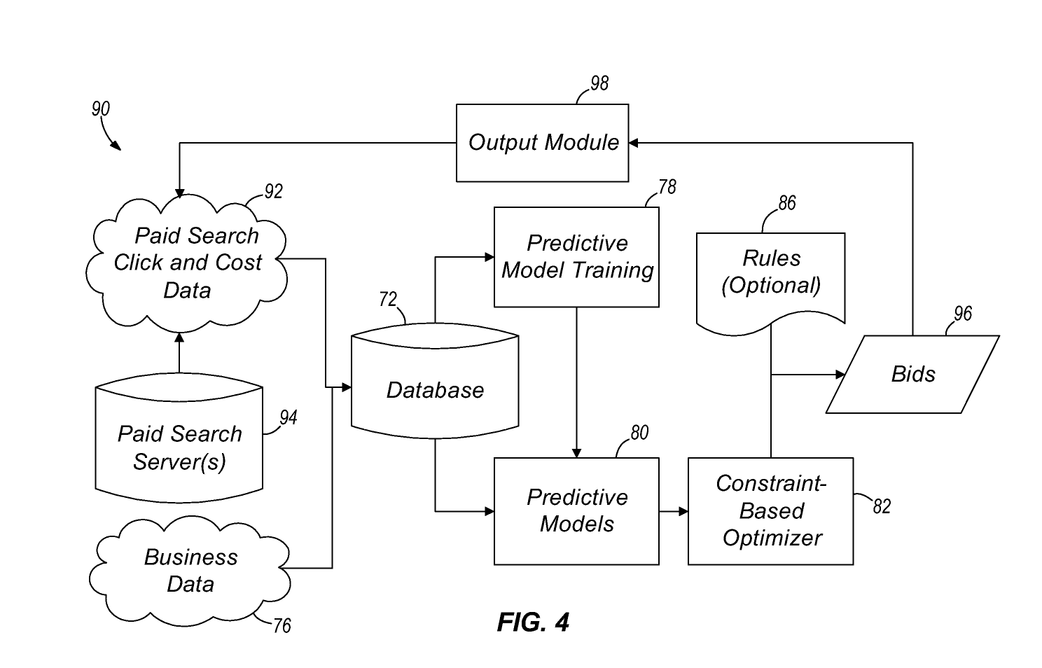

Similarly, FIG. 4 illustrates the system 20 configured as a model-based paid search bid management application or system 90. As shown in FIG. 4, for paid search advertising, the cost data 92 used by the system 90 may come from paid search servers or programs 94, such as Google® AdWords®, Yahoo!® Search Marketing®, and Microsoft® AdCenter®, and the output of the system 90 includes bids 96 rather than advertisement prices 84. The cost data 92 can include information such as cost data from the paid search servers 94, historical advertising reports and/or data, etc. In some embodiments, the system 90 includes one or more adapters that use application programming interfaces (“APIs”) provided by the paid search servers 94 to download and/or process the cost data 92 and/or the business data 76.

The business data 76 and the paid search click and cost data 92 is stored in the database 72 and is used by the predictive model training module 78 to generate the one or more predictive models 80. The predictive models 80 are then used by the constraint-based optimizer 82 to determine the bids 96. As shown in FIG. 4, one or more rules 86 may also optionally be used to determine the bids 96. If rules 86 are used, the system 90 can be considered a hybrid paid search bid management system. The bids 96 generated by the system 90 can be output or uploaded to the paid search servers 94 using an output module 98. In some embodiments, the output module 98 also uses the API adapters, described above, to upload new bids to the paid search servers 94. As illustrated in FIG. 4, the generated bids 96 may also be used by the system 90 during subsequent processing (e.g., as part of the paid search click and cost data 92).

It should be understood that the systems 70 and 90 can include additional modules and/or functionality and the modules and functionality illustrated in FIGS. 3 and 4 be combined and distributed in various configurations. For example, as mentioned above, the systems 70 and 90 may offer various interfaces that allow a user to interact with the systems 70 and 90. The user can interact with the systems 70 and 90 to configure the systems, monitor user access to the systems, and/or monitor bids or prices determined by the systems. The interfaces provided by the systems 70 and 90 may include web-based interfaces (e.g., provided through the web server 34) that can be accessed through a browser application.

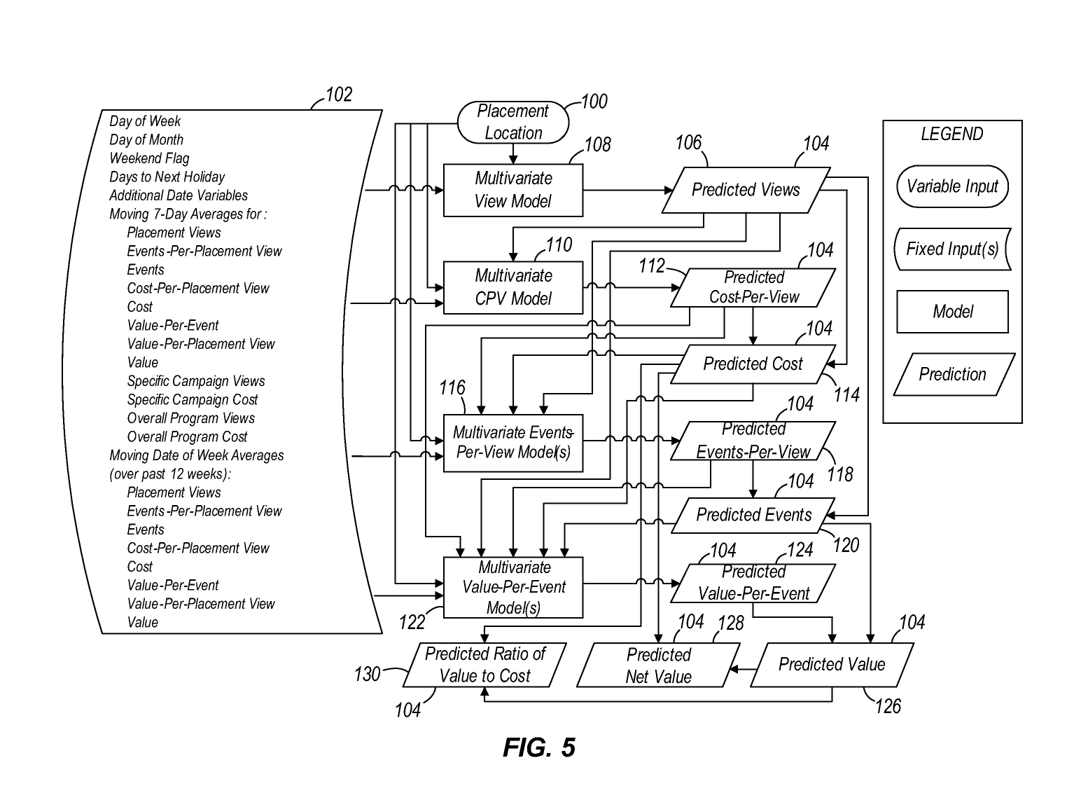

FIGS. 5-8 illustrate methods of predicting future performance of an advertising placement that can be performed by the systems 70 and 90. For example, FIG. 5 illustrates model inputs and sequencing that can be used by the system 70 in the context of advertising pricing within any type of channel or form of advertising (e.g., not limited to Internet paid search advertising). As shown in FIG. 5, the inputs to the various predictive models of the system 70 include a desired placement location 100, static inputs 102 including dates and moving averages, and predictions 104 from various models. Placement location 100 is where an advertisement will be displayed. In the context of a paid search advertisement on the Internet, a placement location is a position or placement on a search results page (e.g., first advertisement slot, second advertisement slot, etc.). However, in the context of other advertising channels, such as television, a placement location can be a particular time of day, day of the week, week of the year, day of the year, channel, a medium, or combinations thereof.

The date inputs can be derived from a specific date, such as a day of the week or a day of the month. The one week moving average inputs can include the average values for a particular metric over the past several days (e.g., over the past seven days). The day of week moving averages can include the average value for a particular metric for the same day of the week over a predetermined period. For example, the day of week moving averages can include an average number of clicks for an advertisement over the past twelve Saturdays. The combination of short term and long term moving average inputs gives the models a balance of stability and agility for predicting future values.

The desired placement location 100 is an independent variable input to the models. The placement location 100, however, can be changed as the model sequence is repeated for multiple iterations. For example, the model sequence illustrated in FIG. 5 can be repeated for multiple placement locations (e.g., positions 1, 2, 3, 4, 5, etc. of advertisements displayed on a search results page) to simulate future performance of an advertisement at various placement locations. These simulations (e.g., performed by the constraint-based optimizer 82) can be used (e.g., analyzed, compared, etc.) to determine a bid for a particular advertisement. The inputs other than the desired placement location 100 are either static for a particular time period (e.g., inputs 102) or derived from a model or other model predictions (e.g., inputs 104). For example, when predicting the number of views for a particular placement on a particular day, the day of week is a constant derived directly from the current date. In some embodiments, all of the historical moving averages are fixed for a particular date since they occurred in the past and cannot be changed.

As shown in FIG. 5, the illustrated model sequencing predicts a number of views 106 using a view model 108. The view model 108 uses the desired placement location 100 and the static inputs 102 to determine the predicted number of views 106. The module sequencing then uses the static inputs 102, the predicted views 106, and the desired placement location 100 as inputs to a cost-per-view model 110. Predicted views 106 do not necessary determine or drive predicted cost-per-view or vice versa. Rather, a predicted cost drives a placement location and a placement location drives impressions or events that generate business value. Therefore, typical model sequences in advertising price management systems do not use predicted views 106 as an input to a cost-per-view model 110. An advantage of using predicted views 106 as an input to the cost-per-view model 110, however, is that predicted values are more responsive to changes in the desired placement location 100. As described above, since the other model inputs are fixed for a given time period, using desired placement location 100 as the only variable input can lead to models that under-predict the change in behavior associated with a change in desired placement location. One method to overcome this problem would be to limit the number of static inputs to the models to give more relative weight to the placement location 100. However, that approach tends to decrease the predictive accuracy of the models. By feeding the predicted views 106 into a cost based model, such as a cost-per-view model or a cost model, the effect of a change in desired placement location 100 is magnified, which allows for more static inputs to be used by the system 70.

Continuing through the model sequence illustrated in FIG. 5, the cost-per-view model 110 generates a predicted cost-per-view 112. The cost-per-view 112 is used to generate a predicted cost 114. The cost-per-view 112 and the predicted cost 114 are then used by one or more events-per-view models 116 (e.g., along with desired placement location 100, static inputs 102, and predicted views 106) to generate a predicted events-per-view 118. The predicted events-per-view 118 is used to generate a predicted number of events 120.

The model sequencing illustrated in FIG. 5 also includes one or more value-per event-models 122. The value-per-event models 122 use the desired placement location 100, the static inputs 102, the predicted views 106, the predicted cost-per-view 112, the predicted cost 114, the predicted events-per-view 118, and the predicted events 120 to determine a predicted value-per-event 124. The value-per-event 124 and the events 120 are used to determine a predicted value 126. The predicted value 126 and the cost 114 are then used to determine a predicted net value 128. The predicted value 126 and the cost 114 are also used to determine a predicted ratio of value to cost 130. Therefore, as shown in FIG. 5, the predicted values determined by models are fed as inputs to subsequent models in the sequence. Overall, this sequencing creates a dynamic sequence of predictive models that is responsive to changes in the advertising desired placement location 100. The predictions are then used to determine a bid for a particular advertisement (e.g., on a particular day). For example, the various predictions 104 generated by the system 70 can be compared with one another (e.g., using the constraint-based optimizer 82) to determine a proper bid for a particular advertisement at a particular time (e.g., for a particular day).

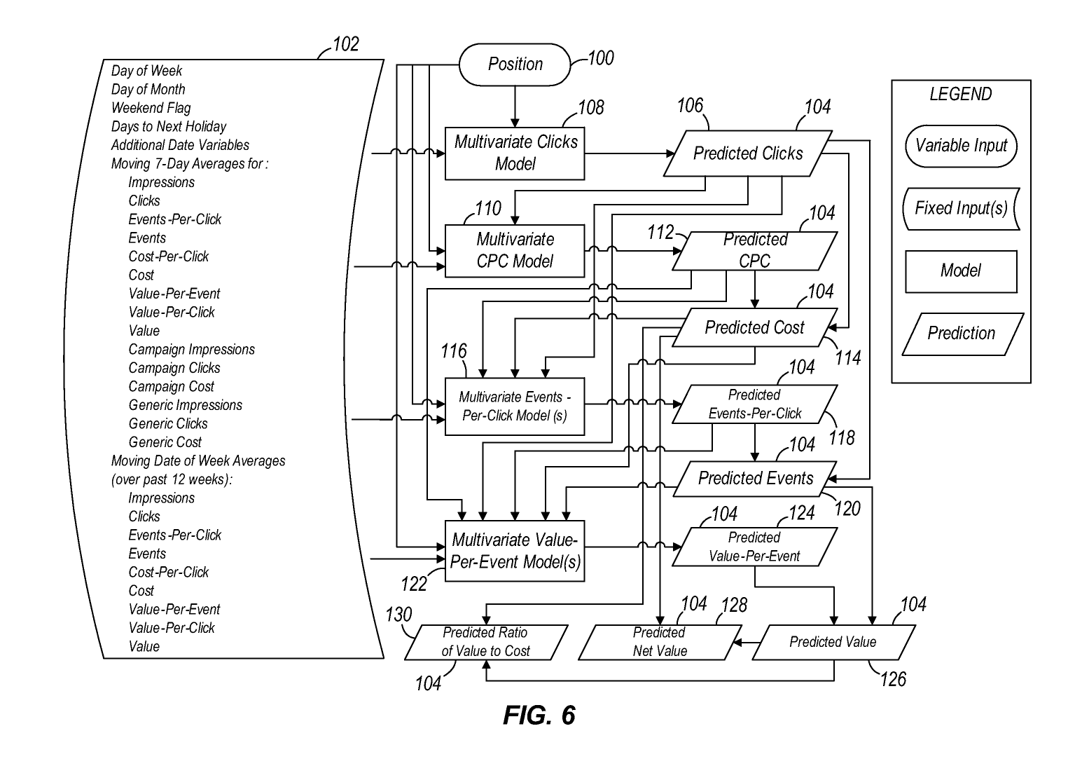

FIG. 6 illustrates model inputs and sequencing for the systems 70 and 90 according to another embodiment of the invention. For example, the inputs and sequencing illustrated in FIG. 6 can be used by the system 90 in the context of managing paid search advertising (e.g., Internet paid search advertising). Therefore, although the model sequencing illustrated in FIG. 6 is similar and uses many of the same inputs as the model sequence illustrated in FIG. 5, the desired placement location 100 of FIG. 5 can be referred to as the desired position 100 in FIG. 6. Similarly, anywhere “view” was referenced in FIG. 5 can be referred to as “click” in FIG. 6.

Accordingly, as shown in FIG. 6, the illustrated model sequencing predicts a number of clicks 106 using a click model 108. The click model 108 uses desired position 100 and the static inputs 102 to determine the number of clicks 106. The module sequencing then uses the static inputs 102, the predicted clicks 106, and the desired position 100 as inputs to a cost-per-click model 110. The cost-per-click model 110 generates a predicted cost-per-click 112. The cost-per-click 112 is used to generate a predicted cost 114. The cost-per-click 112 and the predicted cost 114 are then used by one or more events-per-click models 116 (e.g., along with desired position 100, static inputs 102, and predicted clicks 106) to generate a predicted events-per-clicks 118. The predicted events-per-clicks 118 is used to generate a predicted number of events 120.

One or more value-per-event models 122 use the desired position 100, the static inputs 102, the predicted clicks 106, the predicted cost-per-click 112, the predicted cost 118, the predicted events-per-click 118, and the predicted events 120 to determine a predicted value-per-event 124. The value-per-event 124 and the events 120 are used to determine a predicted value 126. The predicted value 126 and the cost 114 are then used to determine a predicted net value 128. The predicted value 126 and the cost 114 are also used to determine a predicted ratio of value to cost 130.

It should be understood that the models and sequence of models used by the systems 70 and 90 or similar systems can vary. Each sequence can generally start with predicting a number of clicks (or a number of views for advertising pricing applications not limited to Internet paid search advertising), and using the predicted clicks as an input to a cost-based model, such as a cost model, a cost-per-click model, or a cost-per-view model. The output of the cost-based model can then be used as an input to one or more events models, such as an events-per-click model, an events-per-view model, or a total number of events model. The output of the event models can then be used as an input to one or more value models, such as a value-per-event model or a total value model. Furthermore, it should be understood that although predicted clicks and views are used throughout the detailed description as a starting point for model sequences, other events could also be used in the model sequence, such as predicted impressions.

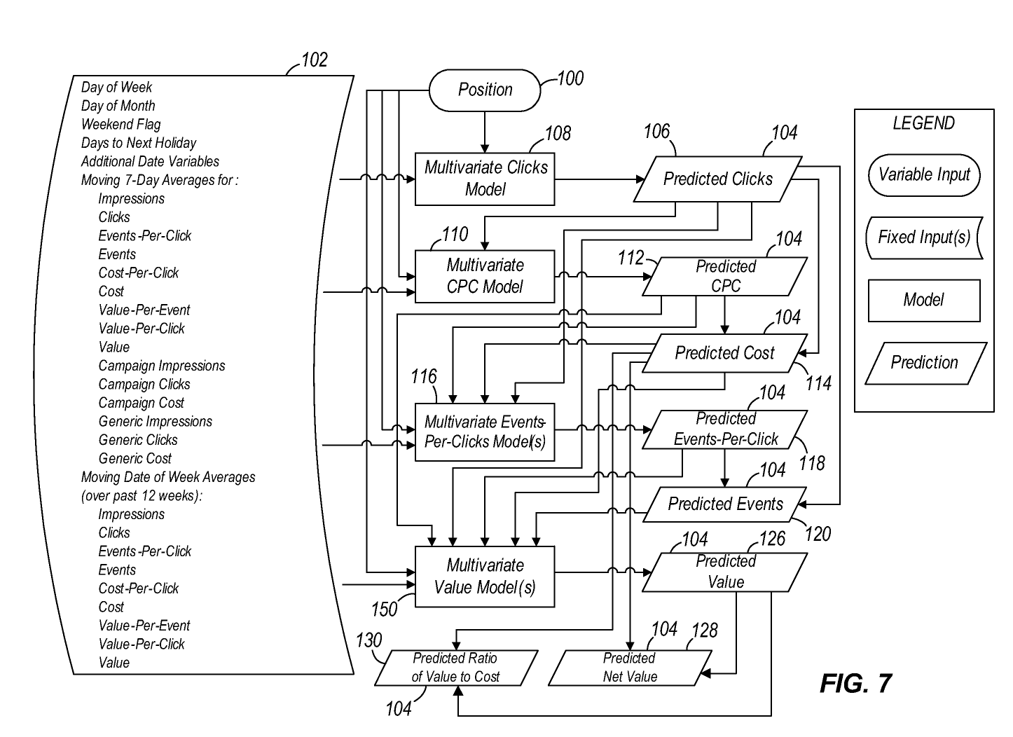

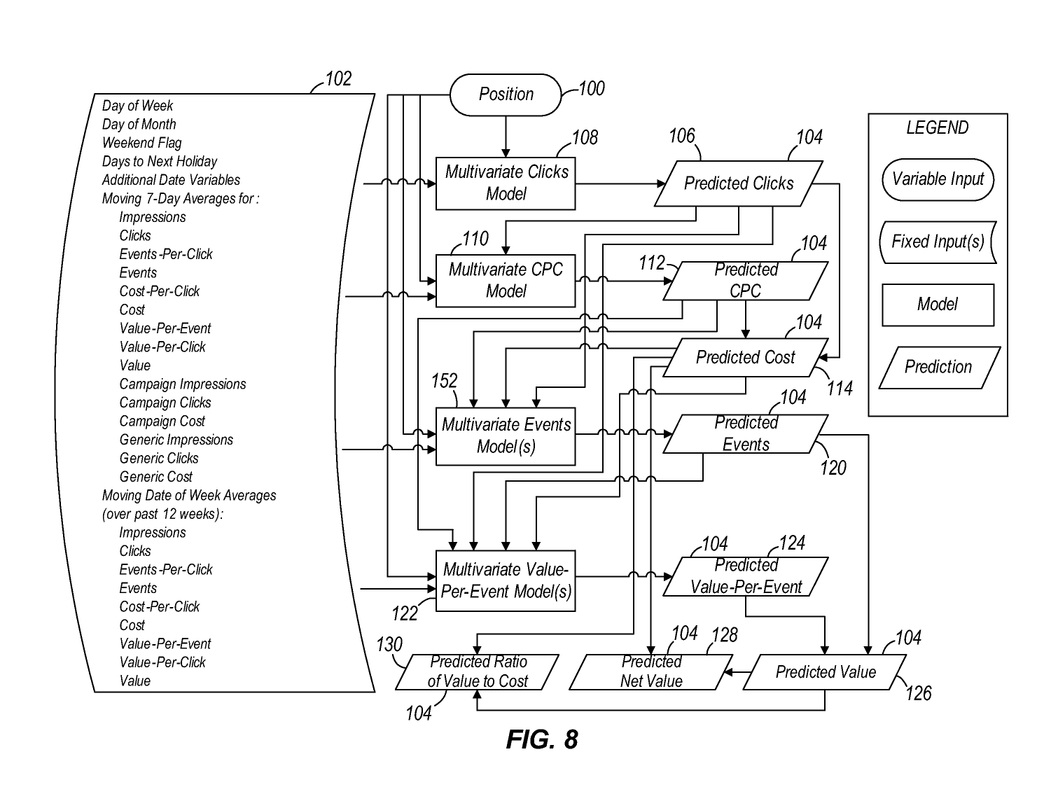

Some model sequences can also exclude value-per-event models or total value models, exclude events-per-click models or number of events models, use a value-per-click or a total value model, or include multiple models that predict different types of events or different types of values. For example, FIG. 7 illustrates a method of predicting future performance of an advertising placement performed by the system 90 where the value-per-event models 122 are replaced with one or more total value models 150. Therefore, the model sequencing illustrated in FIG. 7 generates the predicted value 126 using a model (rather than deriving the predicted value 126 from other predicted outputs as illustrated in FIG. 6) and does not predict a value-per-event 124. Similarly, FIG. 8 illustrates a method of predicting future performance of an advertising placement performed by the system 90 where the events-per-click models 116 are replaced with one or more number of events models 150. Therefore, the model sequencing illustrated in FIG. 8 generates the predicted number of events 120 using a model (rather than deriving the predicted events 120 from other predicted outputs as illustrated in FIG. 6) and does not predict an events-per-click 118.

Also, as described above, an event is an action considered to be of value to a business, such as conversions, orders or sales, leads, or applications or registrations, and events can be assigned a value, such as revenue, margin, or profit. Therefore, the events-per-view or events-per-click models 116 and the number of events models 152 can predict values such as a number of conversions, a number of conversions per click or per view, a number of orders or sales, a number of orders or sales per click or per view, a number of leads, a number of leads per click or per view, a number of applications or registrations, a number of applications or registrations per click or per view, etc. Similarly, the value-per-event models 122 and the total value models 150 can predict values such as a revenue, a revenue per click or per view, a revenue per conversion, a margin, a margin per click or per view, a margin per conversion, a profit, a profit per click or per view, a profit per conversion, etc. It should be understood that more than one event and/or value model may be used in a particular model sequence and multiple event.

Various features and advantages of the invention are set forth in the following claims.

What is claimed is:

1. A computer-implemented method for determining a price for an advertising placement, the method comprising:
setting a desired placement location for an advertising placement;
determining a predicted number of views at the desired placement location for the advertising placement using a views model;
determining a predicted cost at the desired placement location for the advertising placement using a cost model, the cost model using the predicted number of views determined by the views model as input; and
outputting a price for the advertising placement based on at least one of the predicted number of views and the predicted cost at the desired placement location.

2. The method of claim 1, wherein the setting the desired placement location includes setting a desired position for an advertisement on a search results page.

3. The method of claim 2, wherein the determining the predicted number of views includes determining a predicted number of clicks at the desired position for the advertisement using a clicks model.

4. The method of claim 3, wherein the determining the predicted cost includes determining a predicted cost at the desired position for the advertisement using the cost model, the cost model using the predicted number of clicks determined by the clicks model as input.

5. The method of claim 4, wherein the outputting the price includes outputting a bid for the advertisement to at least one paid search server based on at least one of the predicted number of clicks and the predicted cost at the desired position.

6. The method of claim 5, wherein the determining the predicted cost includes determining an average cost-per-click for the advertisement at the desired position.

7. The method of claim 5, wherein the determining the predicted cost includes determining a total cost for the advertisement at the desired position.

8. The method of claim 5, further comprising:
setting a second desired position for the advertisement;
determining a second predicted number of clicks at the second desired position for the advertisement using the clicks model;
determining a second predicted cost at the second desired position for the advertisement using the cost model, the cost model using the second predicted number of clicks determined by the clicks model as input; and
comparing the second predicted cost at the second desired position for the advertisement to the first predicted cost at the first desired position for the advertisement to determine the bid for the advertisement.

9. The method of claim 5, further comprising:
determining a predicted number of events at the desired position for the advertisement using an events model, the event model using the predicted number of clicks determined by the clicks model and the predicted cost determined by the cost model as input.

10. The method of claim 9, wherein the determining the predicted number of events includes determining a predicted number of conversions at the desired position for the advertisement.

11. The method of claim 9, wherein the determining the predicted number of events includes determining a predicted number of conversions per click at the desired position for the advertisement.

12. The method of claim 9, wherein the determining the predicted number of events includes determining a predicted number of sales at the desired position for the advertisement.

13. The method of claim 9, wherein the determining the predicted number of events includes determining a predicted number of sales per click at the desired position for the advertisement.

14. The method of claim 5, further comprising:
determining a predicted value at the desired position for the advertisement using a value model, the value model using the predicted number of clicks determined by the clicks model and the predicted cost determined by the cost model as input.

15. The method of claim 14, wherein the determining the predicted value includes determining a predicted revenue at the desired position for the advertisement.

16. The method of claim 14, wherein the determining the predicted value includes determining a predicted revenue per click at the desired position for the advertisement.

17. The method of claim 14, wherein the determining the predicted value includes determining a predicted revenue per conversion at the desired position for the advertisement.

18. A system for determining a bid for an advertisement displayed in response to a search query, the system comprising:
a clicks model configured to determine a predicted number of clicks at a desired position for an advertisement;
a cost model configured to determine a predicted cost at the desired position for the advertisement using the predicted number of clicks determined by the clicks model as input; and
a module configured to output a bid for the advertisement to at least one paid search server based on at least one of the predicted number of clicks and the predicted cost at the desired position.

19. The system of claim 18, wherein the predicted cost is an average cost-per-click for the advertisement at the desired position.

20. The system of claim 18, wherein the predicted cost is a total cost for the advertisement at the desired position.

21. The system of claim 18, wherein the clicks model is further configured to determine a second predicted number of clicks at a second desired position for the advertisement and the cost model is further configured to determine a second predicted cost at the second desired position for the advertisement using the predicted number of clicks determined by the clicks model as input and wherein the system further comprises a constraint-based optimizer configured to compare the second predicted cost at the second desired position for the advertisement to the first predicted cost at the first desired position for the advertisement.

22. The system of claim 18, further comprising:
an events model configured to determine a predicted number of events at the desired position for the advertisement using the predicted number of clicks determined by the clicks model and the predicted cost determined by the cost model as input.

23. The system of claim 22, wherein the predicted number of events includes a predicted number of conversions at the desired position for the advertisement.

24. The system of claim 22, wherein the predicted number of events includes a predicted number of conversions per click at the desired position for the advertisement.

25. The system of claim 22, wherein the predicted number of events includes a predicted number of sales at the desired position for the advertisement.

26. The system of claim 22, wherein the predicted number of events includes a predicted number of sales per click at the desired position for the advertisement.

27. The system of claim 18, further comprising:
a value model configured to determine a predicted value at the desired position for the advertisement using the predicted number of clicks determined by the clicks model and the predicted cost determined by the cost model as input.

28. The system of claim 27, wherein the predicted value includes a predicted revenue at the desired position for the advertisement.

29. The system of claim 27, wherein the predicted value includes a predicted revenue per click at the desired position for the advertisement.

30. The system of claim 27, wherein the predicted value includes a predicted revenue per conversion at the desired position for the advertisement.

31. Non-transitory computer-readable medium encoded with a plurality of processor-executable instructions for:
setting a desired position for an advertisement;
determining a predicted number of clicks at the desired position for the advertisement using a clicks model;
determining a predicted cost at the desired position for the advertisement using a cost model, the cost model using the predicted number of clicks determined by the clicks model as input; and
outputting a bid for the advertisement to at least one paid search server based on at least one of the predicted number of clicks and the predicted cost at the desired position.

32. A system for determining a bid for an advertisement, the system comprising:
a first model configured to output a predicted number of customer impressions at a desired position for an advertisement;
a second model configured to output a predicted cost for the advertisement using an output of the first model as input; and
a module configured to output a bid for the advertisement based on the output of at least one of the first model and the second model.

33. The system of claim 32, wherein the desired position includes at least one of a placement on a computer screen, a time of day, a day of the week, a week of the year, a day of the year, a channel, and a medium.

34. The system of claim 32, wherein the module outputs the bid to at least one paid search server.
